(19) United States
(12) Patent Application Publication
(10) Pub. No.: US 2014/0043578 A1
(43) Pub. Date: Feb. 13, 2014

(54) DISPLAY DEVICE

(71) Applicant: AU Optronics Corp., Hsin-Chu (TW)

(72) Inventors: Shiuan-Iou Lin, Hsin-Chu (TW); Pin-Hsiang Chiu, Hsin-Chu (TW); Wen-Yuan Li, Hsin-Chu (TW); Tai-Hsiang Huang, Hsin-Chu (TW)

(21) Appl. No.: 13/921,181

(22) Filed: Jun. 18, 2013

(30) Foreign Application Priority Data
Aug. 7, 2012 (TW) 101128403

(51) Int. Cl. G02F 1/1339

(52) U.S. Cl. CPC G02F 1/1339
USPC 349/153; 428/194

(57) ABSTRACT

A display device includes a first flexible substrate, a second flexible substrate and a patterned sealant. The patterned sealant is disposed between the first flexible substrate and the second flexible substrate. The patterned sealant includes a hollow rectangular pattern, which is disposed in a peripheral region of the first flexible substrate, and has a rectangular opening corresponding to an active region of the first flexible substrate. The rectangular opening has a long side parallel to a first direction and a short side parallel to a second direction, and the long side has a long side length x1 and the short side has a short side length y1. The hollow rectangular pattern has a first width x2 in the first direction, and a second width y2 in the second direction, wherein y2≦x2, y1≧x1 and 10≦y1/y2≦90.

### BACKGROUND OF THE DISCLOSURE

1. Field of the Disclosure

The present disclosure relates to a display device and an optical modulation device, and more particularly, to the display device of high reliability and the optical modulation device of high reliability.

2. Description of the Prior Art

With the advantage of flexibility, flexible display devices may be widely applied to various electronic products, for example, an e-paper. However, comparing to hard display devices, because flexible substrates of the flexible display devices are flexible, display components cannot be directly formed on the flexible substrates. Generally speaking, the process of fabricating a conventional flexible display device is as follows. First, two flexible substrates are fixed on two hard substrates, such as glass substrates, with two adhesive layers respectively. Then, the required display components, such as a thin film transistor device and a color filter, are fabricated on the two flexible substrates respectively. Then, the two flexible substrates adhere to each other with the patterned sealant. Finally, a de-bonding process is performed so as to separate the two hard substrates from the two corresponding flexible substrates. The adhesion of the sealant with which the two flexible substrates adhere to each other must be stronger than the adhesion of the adhesive layer with which the flexible substrates adhere to the hard substrates. Therefore, in the de-bonding process, the flexible substrates can be separated from the hard substrates without damaging the flexible display device.

In the process of fabricating the conventional flexible display device, because the yield of the de-bonding process is low, the resulting reliability of flexible display device is poor. It has become the main issue of flexible display device in mass production.

### SUMMARY OF THE DISCLOSURE

It is one of the objectives of the disclosure to provide a display device of high reliability.

An embodiment of the present disclosure provides a display device. The display device includes a first flexible substrate, a second flexible substrate and a patterned sealant. The first flexible substrate has an active region and a peripheral region surrounding the active region. The second flexible substrate is disposed opposite to the first flexible substrate. The patterned sealant is disposed between the first flexible substrate and the second flexible substrate so that the first flexible substrate adheres to the second flexible substrate. The patterned sealant includes a hollow rectangular pattern disposed in a peripheral region of the first flexible substrate. The hollow rectangular pattern has a rectangular opening substantially corresponding to an active region of the first flexible substrate. The rectangular opening has a long side parallel to a first direction and a short side parallel to a second direction. The long side has a long side length x1 and the short side has a short side length y1. The hollow rectangular pattern has a first width x2 in the first direction, and a second width y2 in the second direction. The long side length x1 of the long side and the short side length y1 of the short side of the rectangular opening, and the first width x2 and the second width y2 of the hollow rectangular pattern satisfy the following relations: y2≧x2, y1≦x1 and 10≦y1/y2≦90.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a top view of the display device according to an embodiment of the present disclosure.

FIG. 2 is a cross-sectional view diagram taken along the second direction in FIG. 1.

FIGS. 3-6 are schematic diagrams illustrating a method of fabricating a display device according to an embodiment of this disclosure.

### DETAILED DESCRIPTION

To provide a better understanding of the present disclosure, features of the embodiments will be made in detail. The embodiments of the present disclosure are illustrated in the accompanying drawings with numbered elements. In addition, the terms such as “first” and “second” described in the present disclosure are used to distinguish different components or processes, which do not limit the sequence of the components or processes.

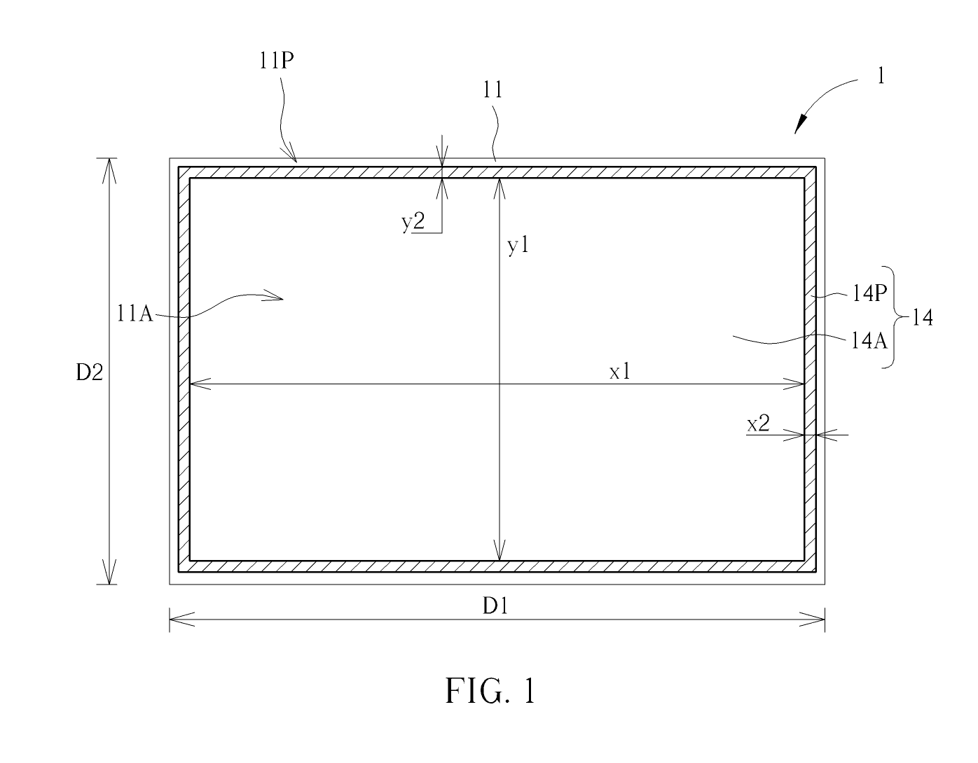

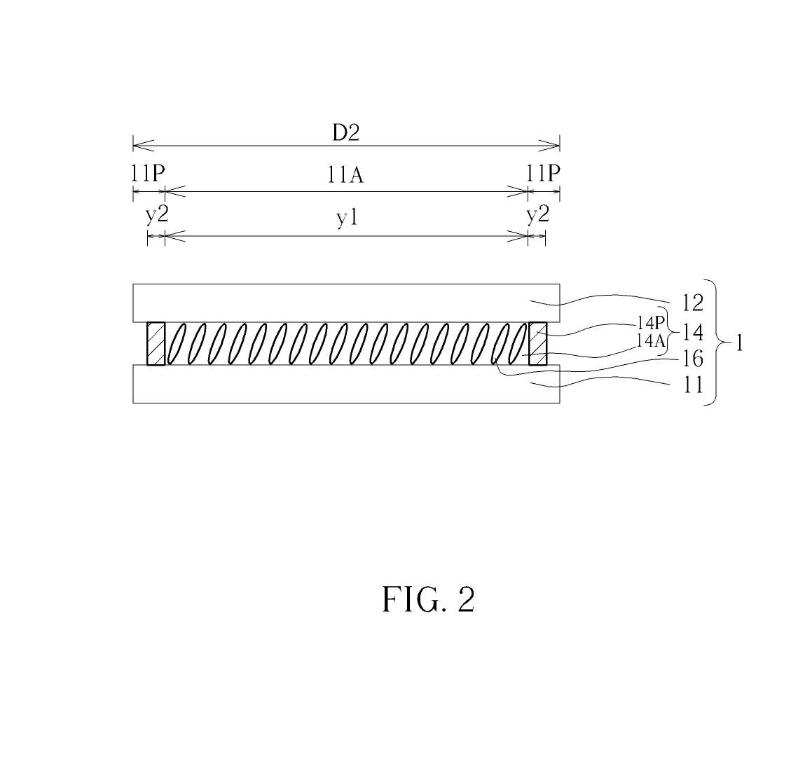

Please refer to FIGS. 1-2, which are schematic diagrams illustrating a display device according to an embodiment of this disclosure. FIG. 1 is the schematic diagram illustrating a top view of the display device according to the embodiment of the present disclosure. FIG. 2 is the cross-sectional view diagram taken along the second direction D2 in FIG. 1. To highlight the feature of the display device in this embodiment, the second flexible substrate is omitted in FIG. 1. As shown in FIGS. 1-2, the display device 1 in this embodiment includes a first flexible substrate 11, a second flexible substrate 12 and a patterned sealant 14. The first flexible substrate 11 has an active region 11A and a peripheral region 11P surrounding the active region 11A. The second flexible substrate 12 is disposed opposite to the first flexible substrate 11. In this embodiment, the first flexible substrate 11 and the second flexible substrate 12 may include a flexible plastic film respectively, but not limited thereto. The material of the first flexible substrate 11 and the second flexible substrate 12 may include, for example, polyimide (PI), cyclo olefin copolymer (COC), polymethyl methacrylate (PMMA), polyethylene terephthalate (PET), polyethylene naphthalate (PEN), Poly(ether sulfone) (PES), polycarbonate (PC), copolyester thermoplastic elastomer (COP), polysulfone (PS), phenolic resin, epoxy resin, polyester, polyetheramide, cellulose acetate, aliphatic polyurethane, polyacrylonitrile, polytetrafluoro ethylenes, polyvinylidene fluoride, high density ethylene (HDPE), poly(methyl α-methacrylates) or mixtures thereof. Moreover, the first flexible substrate 11 and the second flexible substrate 12 are preferably transmissive to light. The thickness of the first flexible substrate 11 and the second flexible substrate 12 are substantially between 10 micrometers (μm) and 500 μm respectively, but not limited thereto. The patterned sealant 14 is disposed between the first flexible substrate 11 and the second flexible substrate 12 so that the first flexible substrate 11 adheres to the second flexible substrate 12. The patterned sealant 14 includes a hollow rectangular pattern 14P disposed in the peripheral region 11P of the first flexible substrate 11. The hollow rectangular pattern 14P has a rectangular opening 14A substantially corresponding to the active region 11A of the first flexible substrate 11. In other words, the hollow rectangular pattern 14P of the patterned sealant 14 defines the rectangular opening 14A. The rectangular opening 14A has a long side parallel to a first direction D1 and a short side parallel to a second direction D2. The long side has a long side length x1 and the short side has a short side length y1. The hollow rectangular pattern 14P has a first width x2 in the first direction D1 and a second width y2 in the second direction D2. The patterned sealant 14 may include, for example, an ultraviolet sealant, which can be hardened when irradiated by ultraviolet light. The material of the patterned sealant 14 may include acrylics or acrylic epoxy, but not limited thereto. In this embodiment, the long side length x1 of the long side and the short side length y1 of the short side of the rectangular opening 14A, and the first width x2 and the second width y2 of the hollow rectangular pattern 14P satisfy the following relations: y2≦x2 and y1≦x1. Moreover, the short side length y1 of the short side of the rectangular opening 14A and the second width y2 of the hollow rectangular pattern 14P satisfy the following relations: 10≦y1/y2≦90, 10≦y1/y2≦85 preferably, 10≦y1/y2≦65 preferably, 10≦y1/y2≦53 preferably, or 10≦y1/y2≦36 preferably. Moreover, the second width y2 of the hollow rectangular pattern 14P is substantially between 1500 μm and 10000 μm, or preferably between 2100 m and 6000 μm, but not limited thereto.

The display device 1 of this embodiment further includes an optical modulation medium layer 16 (as shown in FIG. 2). The optical modulation medium layer 16 is disposed between the first flexible substrate 11 and the second flexible substrate 12, and the optical modulation medium layer 16 is sealed by the patterned sealant 14. With the optical modulation characteristic, the optical modulation medium layer 16 can, for example, change the polarization direction of light. For example, the optical modulation medium layer 16 may include liquid crystal layer, but not limited thereto. The display device 1 of this embodiment may be a flexible display device, and in this case, the optical modulation medium layer 16 serves as a display medium layer to control the gray level of the flexible display device. For example, the flexible display device may be liquid crystal display device. In the case, the display medium layer may be liquid crystal layer in which the liquid crystal molecules may be driven to change the polarization direction of light, thereby controlling the gray level of the liquid crystal display device. The flexible display devices are not limited to the liquid crystal display device, but may be other types of flexible display devices, such as an organic light-emitting diode display device or an electrophoresis display device. Moreover, the structure of the display device 1 in this embodiment may have other applications—for example, this structure may be serves as a 2D and 3D switchable display device, such as a liquid crystal lens (LC lens) or a parallax barrier.

In the display device 1 of this embodiment, because the long side length x1 of the long side and the short side length y1 of the short side of the rectangular opening 14A of the patterned sealant 14, and the first width x2 and the second width y2 of the hollow rectangular pattern 14P satisfy the above-mentioned relations, without dramatically enlarging the dimension of the patterned sealant 14, the adhesion among the patterned sealant 14, the first flexible substrate 11 and the second flexible substrate 12 is still strong enough to prevent the optical modulation medium layer 16 of the display device 1 from foaming or leaking in the de-bonding process. Moreover, the dimension of the peripheral region 11P is not required to be enlarged so that the display device may be a narrow border design. The method for fabricating the display device of the present disclosure and the effect of the patterned sealant with the above-mentioned dimension will be illustrated as follows.

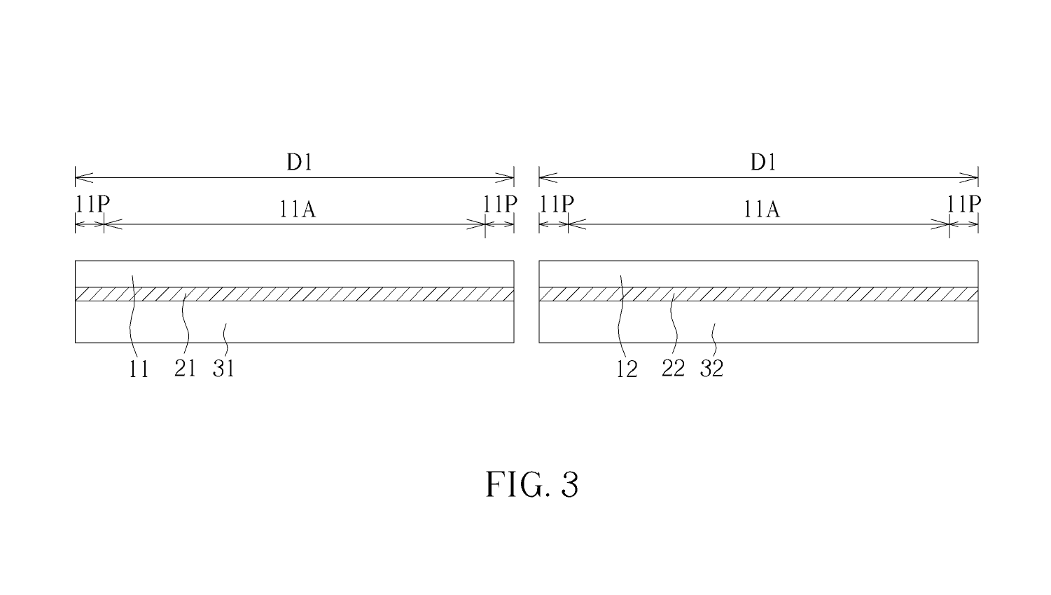

Please refer to FIGS. 3-6, and also refer to FIGS. 1-2. FIGS. 3-6 are schematic diagrams illustrating a method of fabricating a display device according to an embodiment of this disclosure. FIGS. 3-6 are cross-sectional view diagrams taken along the first direction D1 in FIG. 1. As shown in FIG. 3, first, the first flexible substrate 11 and the second flexible substrate 12 are provided. Then, the first flexible substrate 11 adheres to and is fixed on a first hard substrate 31 with a first adhesive layer 21. The second flexible substrate 12 adheres to and is fixed on a second hard substrate 32 with a second adhesive layer 22. The first hard substrate 31 and the second hard substrate 32 may include a glass substrate respectively, but not limited thereto.

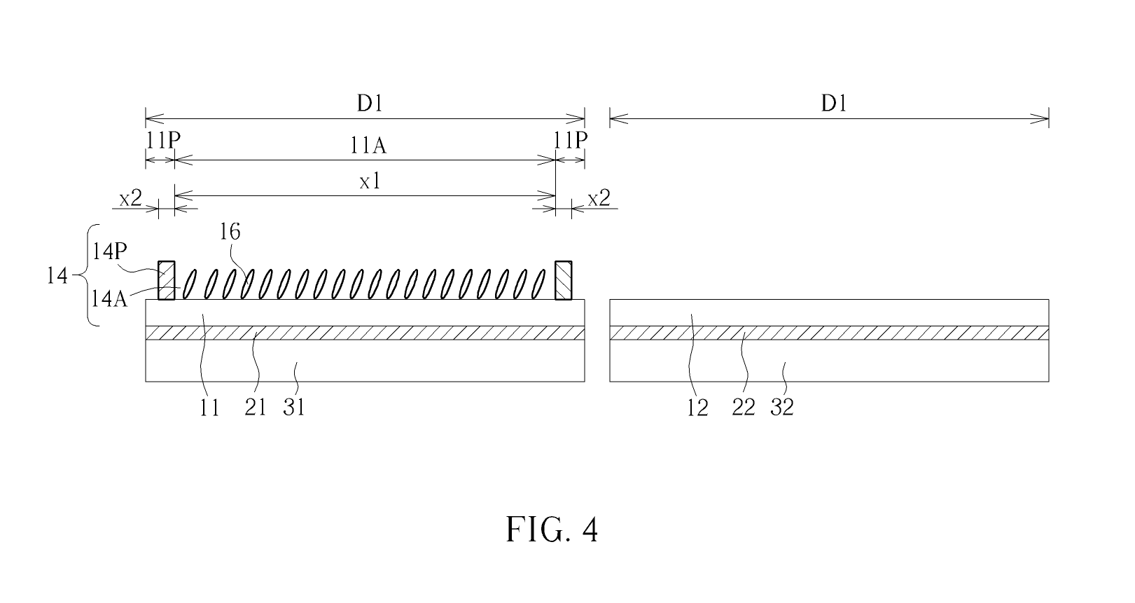

As shown in FIG. 4, the required components and films (not shown) are fabricated on the first flexible substrate 11 and the second flexible substrate 12, respectively. In the display device of this embodiment, it takes a liquid crystal display device for example. Therefore, main components, such as a thin film transistor device, a protective layer and a pixel electrode, can be formed on the first flexible substrate 11. Components, such as a black matrix, a color filter, a common electrode and a spacer, can be formed on the second flexible substrate 12. Moreover, the display devices may be applied on other kinds of optical modulation devices, such as an organic light-emitting diode display device, an electrophoresis display device, a liquid crystal lens (LC lens) and a parallax barrier; the required components and films can be respectively fabricated on the first flexible substrate 11 and the second flexible substrate 12 according to the different applications. The patterned sealant 14 is formed in the peripheral region 11P on the first flexible substrate 11. The optical modulation medium layer 16 is formed in the active region 11A on the first flexible substrate 11. The patterned sealant 14 includes the hollow rectangular pattern 14P and the rectangular opening 14A. The long side length x1 of the long side and the short side length y1 of the short side of the rectangular opening 14A, and the first width x2 and the second width y2 of the hollow rectangular pattern 14P satisfy the above relations as shown in FIGS. 1-2 and other related illustration. In this embodiment, the optical modulation medium layer 16 is a liquid crystal layer, and may be form of liquid crystal molecules by one drop fill (ODF) process, but not limited thereto.

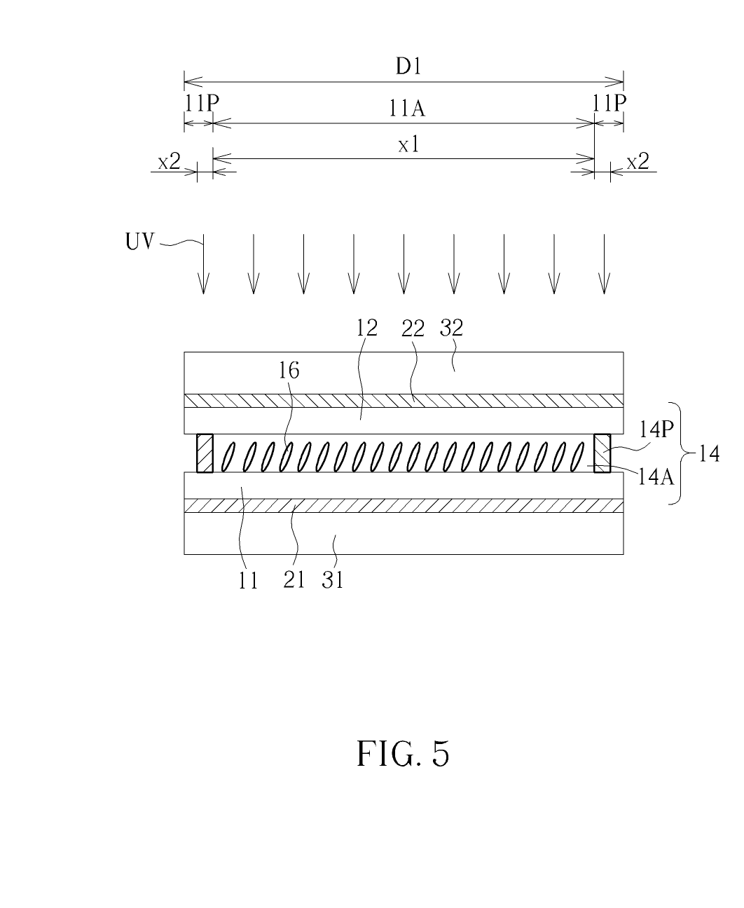

As shown in FIG. 5, the first flexible substrate 11 adheres to the second flexible substrate 12 with the hollow rectangular pattern 14P of the patterned sealant 14. In this embodiment, the hollow rectangular pattern 14P is an ultraviolet sealant. The hollow rectangular pattern 14P will be hardened and become adhesive when ultraviolet light irradiates the patterned sealant 14. Therefore, the first flexible substrate 11 adheres to the second flexible substrate 12 tightly, and the optical modulation medium layer 16 is sealed between the first flexible substrate 11 and the second flexible substrate 12. The hollow rectangular pattern 14P of the patterned sealant 14 may be other kinds of light-harden sealants and can be hardened by light at other wavelength. The hollow rectangular pattern 14P of the patterned sealant 14 may also be thermosetting sealants which can be hardened by heating, but not limited thereto.

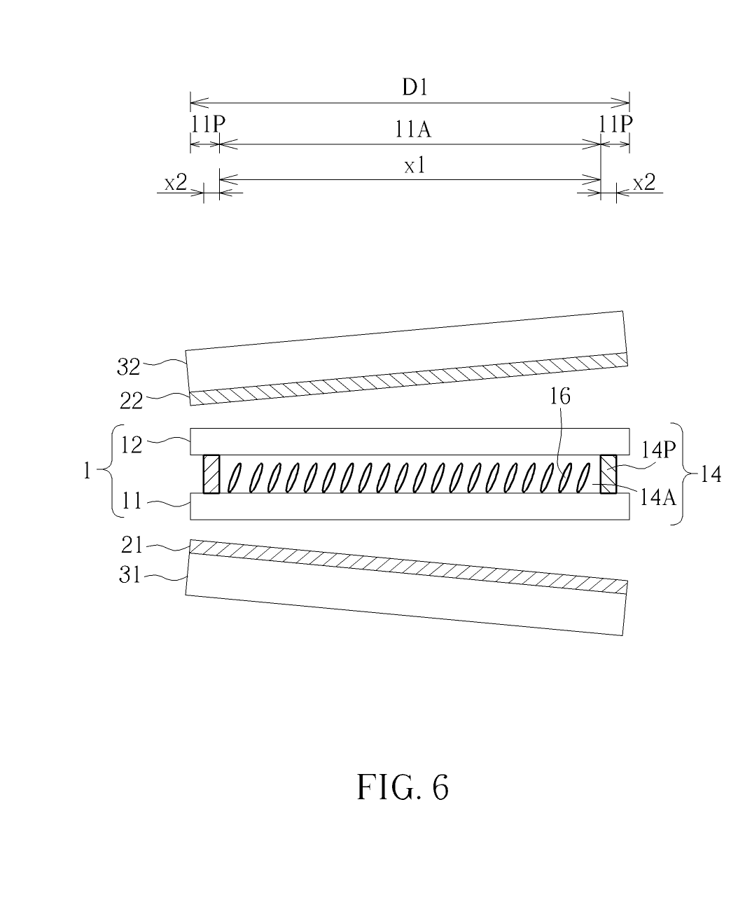

As shown in FIG. 6, a de-bonding process is performed to separate the first hard substrate 31 and the first adhesive layer 21 from the first flexible substrate 11 and to separate the second hard substrate 32 and the second adhesive layer 22 from the second flexible substrate 12. Accordingly, the display device 1 of the embodiment is accomplished. In this embodiment, the first hard substrate 31 and the second hard substrate 32 are removed from the first flexible substrate 11 and the second flexible substrate 12 along the direction parallel to the long side of the rectangular opening 14A (i.e., the first direction D1). Moreover, in the display device 1 of this embodiment, because the long side length x1 of the long side and the short side length y1 of the short side of the rectangular opening 14A of the patterned sealant 14, and the first width x2 and the second width y2 of the hollow rectangular pattern 14P satisfy the above-mentioned relations, the adhesion among the patterned sealant 14, the first flexible substrate 11 and the second flexible substrate 12 is strong enough to prevent the optical modulation medium layer 16 of the display device 1 from foaming or leaking in the de-bonding process. Because the adhesion of the patterned sealant 14 is strong enough in the above-mention region, the dimension of the peripheral region 11P is not required to be enlarged dramatically so that the display device has a narrow border design.

Please refer to table 1. The test results of the averaged adhesion of the substrate and the patterned sealant of different materials, the test results of the patterned sealant in the de-bonding process are listed in Table 1 below.

TABLE 1

| | the averaged | | | |
|---|---|---|---|---|
| | adhesion of the | | | |
| | substrate and the | | | |
| the material of | patterned sealant of | | | |
| the patterned | different materials | y2 | | the test results of the |
| sealant | (N/mm) | (μm) | y1/y2 | de-bonding process |
| material 1 | 0.93 | 900 | 153 | NG |
| (acrylics) | | 1000 | 137 | NG |
| | | 1600 | 86 | NG |
| | | 2600 | 53 | OK |
| | | 3800 | 36 | OK |
| | | 4800 | 28 | OK |
| | | 5300 | 26 | OK |
| material 2 | 1.29 | 1500 | 91 | NG |
| (acrylics) | | 2100 | 65 | OK |
| | | 2200 | 62 | OK |
| | | 2600 | 53 | OK |
| | | 3500 | 39 | OK |
| material 3 | 0.05 | 900 | 153 | NG |
| (acrylic epoxy) | | | | |
| material 4 | 0.05 | 2200 | 63 | OK |
| (acrylic epoxy) | | | | |

From the above-mentioned test results, when the ratio of the short side length y1 of the short side of the rectangular opening of the patterned sealant to the second width y2 of the hollow rectangular pattern of the patterned sealant is substantially between 10 and 90 (i.e., 10≦y1/y2≦90), the adhesion among the patterned sealant and the two flexible substrates is stronger than the adhesion among the adhesive layers (i.e., the first adhesive layer and the second adhesive layer), the flexible substrates and the hard substrates. Therefore, in the de-bonding process, a de-bonding force weaker than the adhesion of the patterned sealant and stronger than the adhesion of the adhesive layers is provided, the hard substrates can be separated from the flexible substrates effectively while the first flexible substrate still adheres to the second flexible substrate by the patterned sealant effectively. At the same time, the patterned sealant is not damaged. Moreover, the display device can also pass reliability tests.

To sum up, when the ratio of the short side length y1 of the short side of the rectangular opening of the patterned sealant to the second width y2 of the hollow rectangular pattern of the patterned sealant is substantially between 10 and 90, the adhesion is strong enough and the hard substrate can be separated from the flexible substrate effectively in the de-bonding process. Moreover, when the ratio of the short side length y1 of the short side of the rectangular opening of the patterned sealant to the second width y2 of the hollow rectangular pattern of the patterned sealant is in the above-mentioned range, the display device can also pass reliability tests.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device, comprising:
a first flexible substrate, wherein the first flexible substrate has an active region and a peripheral region surrounding the active region;
a second flexible substrate disposed opposite to the first flexible substrate; and
a patterned sealant disposed between the first flexible substrate and the second flexible substrate to adhere to the first flexible substrate and the second flexible substrate, wherein the patterned sealant comprises a hollow rectangular pattern disposed in the peripheral region, the hollow rectangular pattern has a rectangular opening substantially corresponding to the active region, the rectangular opening has a long side parallel to a first direction and a short side parallel to a second direction, the long side has a long side length x1, the short side has a short side length y1, and the hollow rectangular pattern has a first width x2 in the first direction and a second width y2 in the second direction;
wherein the long side length x1 of the long side and the short side length y1 of the short side of the rectangular opening, and the first width x2 and the second width y2 of the hollow rectangular pattern satisfy the following relations:
y2≧x2, y1≦x1 and 10≦y1/y2≦90.

2. The display device according to claim 1, wherein the first flexible substrate and the second flexible substrate comprise a flexible plastic film respectively.

3. The display device according to claim 1, wherein the second width of the hollow rectangular pattern is in a range between 1500 micrometers (μm) and 10000 μm.

4. The display device according to claim 1, further comprising an optical modulation medium layer, wherein the optical modulation medium layer is disposed between the first flexible substrate and the second flexible substrate, and the optical modulation medium layer is sealed by the patterned sealant.

5. The display device according to claim 4, wherein the optical modulation medium layer comprises a liquid crystal layer.

6. The display device according to claim 1, wherein the patterned sealant is hardened by light irradiating or heating.

7. The display device according to claim 6, wherein the patterned sealant comprises one of acrylics or acrylic epoxy.
